(19) United States
(12) Patent Application Publication
(10) Pub. No.: US 2002/0117077 A1
(43) Pub. Date: Aug. 29, 2002

(54) Stor-temp containers

(76) Inventor: E. James Johannes, Marietta, GA (US)

Correspondence Address: Moore Ingram Johnson & Steele, LLP, 192 Anderson Street, Marietta, GA, 30060, US

(21) Appl. No.: 10/079,682

(22) Filed: Feb. 20, 2002

Related U.S. Application Data
(60) Provisional application No. 60/271,930, filed on Feb. 21, 2001.

(51) Int. Cl. B65D 25/24; B60L 9/00

(52) U.S. Cl. 104/287; 220/480

(57) ABSTRACT

A stand-alone retractable overhead storage system. The system will be titled STOR-TEMP CONTAINER SYSTEM. The philosophy behind the system is to provide badly needed storage space in the unused portion of a room or garage structure. This area is the upper portion of the building structure such as the ceiling and upper wall area. The Container is loaded at the floor level and the lid secured; it is then retracted up to the ceiling area. The Container, when retracted up to the ceiling, allows the space beneath it to be utilized for traffic, vehicle parking or additional temporary storage. It is a stand-alone structural and functional kit. The Container has two (2) sets of wheels which operate inside of a dual track assembly. This permits easy and safe elevation to the stored position. The Container operates in an up and down motion by way of an electric motor through a cable and pulley system or a chain and sprocket system. The Container will be applied to the residential and commercial housing market.

### CROSS REFERENCE TO RELATED APPLICATIONS

This utility application is the non-provision application of Provisional Application 60/271,930 filed on Feb. 21, 2001.

### STATEMENT REGARDING FEDERALLY SPONSORED RESEARCH OR DEVELOPMENT

Not Applicable

### REFERENCE TO SEQUENCE LISTING

Not Applicable

### BACKGROUND OF THE INVENTION

This Invention pertains to a retractable overhead storage system for the residential and commercial housing industry. In this industry, cost reduction and limited space has cut storage areas to a minimum. All available space is being utilized for day-to-day activities without storage in mind. Deed restrictions and covenants have restricted outside storage buildings. In some areas, vehicles must be stored inside, thus reducing the garage area as storage. The remaining area for storage is above the useable floor area, such as the attic and the area below the ceiling. The attic area storage is limited by the trap door size and the somewhat unsafe wooden steps getting to the attic, and having to carry the stored items in hand. Row houses and condominiums have limited storage in closets and in front of the vehicle parking area in the garage area.

The invention is a retractable storage system that utilizes the unused, yet highly visible, space at the ceiling area adjacent to the walls, upper corner of the room in garages and storage rooms; for example, the area above the vehicles being parked in the garage. The System can be installed and used in areas that are in a normal traffic pattern or are being used for temporary storage underneath this retractable storage system. The area would only be required to be clear when the retractable system was in the loading or unloading position.

### BRIEF SUMMARY OF THE INVENTION

The object of this Invention is to provide out-of-the-way convenient storage to the housing and business building market. The invention is a storage system utilizing unused space above the heads and/or over vehicles in garages and storage rooms in the business and private sectors. The large, lightweight container is loaded on the floor with the items to be stored. The large label is used to identify the stored items. Attached to a wall mounted structure is a pair of steel tracks. These tracks are formed in a “C” section to trap the container's two (2) sets of wheels. The wheels are mounted on two (2) axles through the container. The container motor is activated by a hand-held battery powered device such as a garage door opener. The electric motor lifts the container by way of a pulley and cable, or a chain and sprocket to the overhead storage position; the safety latch is then engaged. Normal traffic can safely pass under the storage container. Vehicles and other items can be safely stored beneath it and not moved until access is required.

The invention is a stand-alone system. The structure is designed to carry the completely loaded container and all of the system components internally. It is a freestanding assembly secured to the wall and ceiling. It is secured to the wall of the building by studs and to the ceiling rafters with wood reinforcements and metal clips. The System is designed as a kit. The kit contains a large plastic or composite container with a locking lid, an electric-powered motor activated by a hand held battery powered device, a mounting structure with steel tracks, wheels, pulley cables or chains, safety latches securing the container in the stored position, and floor/wall warning placards and overload sensors.

### BRIEF DESCRIPTION OF THE SEVERAL VIEWS OF THE DRAWINGS

The following Figures with Items clearly marked will present the unique invention design function and examples of location:

FIG. 1 is a view of a single system and all the details in the loading position;

FIG. 2 is a view of a single system and all the details in a stored position;

FIG. 3 is a view of a dual system, one in the loading position and one in the stored position;

FIG. 4 is a view of a dual system in a stored position;

FIG. 5 is a typical side view showing the details;

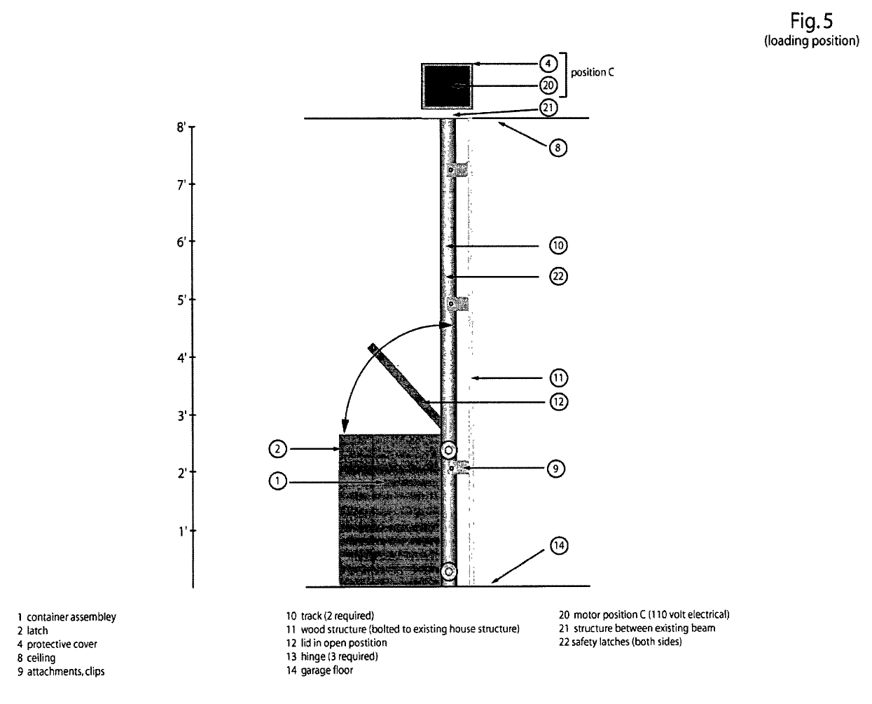

FIG. 6 is a view illustrating a residential usage;

FIG. 7 is a view showing another typical usage;

### REFERENCE NUMBERS IN DRAWINGS

Item 1 is the Container Assembly

Item 2 is the Latch

Item 3 is the Transparent I.D. Window

Item 4 is the Protective Cover

Item 5 is the Motor @ position A

Item 6 is the Remote Control

Item 7 is the center line of the assembly

Item 8 is the ceiling

Item 9 is the Attachments, clips

Item 10 is the Tracks (2 req'd)

Item 11 is the wood structure

Item 12 is the Lid in open position

Item 13 is the Hinge (3 req'd)

Item 14 is the garage floor

Item 15 is the caution area

Item 16 is the Motor @ position B

Item 17 is the Chain or Cable assembly

Item 18 is the Axle Assembly (2 req'd)

Item 19 is the Wheels (4 req'd)

Item 20 is the Motor @ position C

Item 21 is the structure between the existing beams

Item 22 is the Safety Latches (2 req'd)

### DETAILED DESCRIPTION OF THE INVENTION

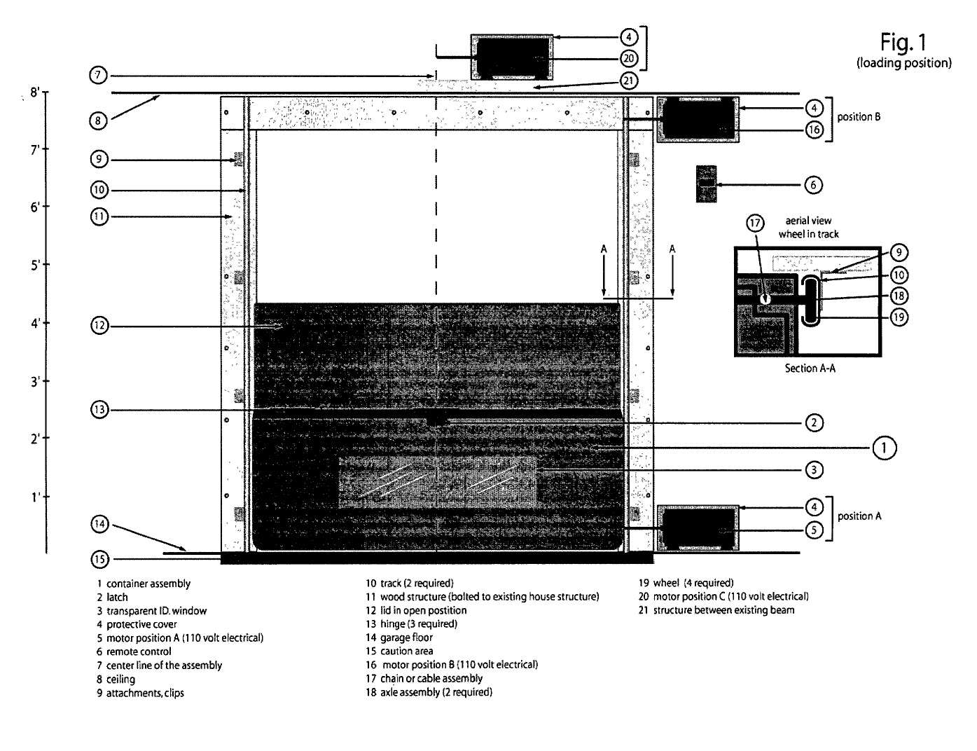

With reference to the figures and items illustrated with detailed explanation is first the Container. The CONTAINER, FIG. 1, ITEM 1, is a rectangular tub-shaped assembly fabricated from plastic, composite or lightweight aluminum or steel. It will be a double or single wall construction. A HINGED LID, FIG. 1, ITEM 12, will be attached by HINGES, FIG. 1, ITEM 13, and secured by LOCKING DEVISES, FIG. 1, ITEM 2, at the front. A TRANSPARENT WINDOW, FIG. 1, ITEM 3, will be provided at the front area to add identification information of the contents. The inside will be configured for optional partition or separators to divide contents if required.

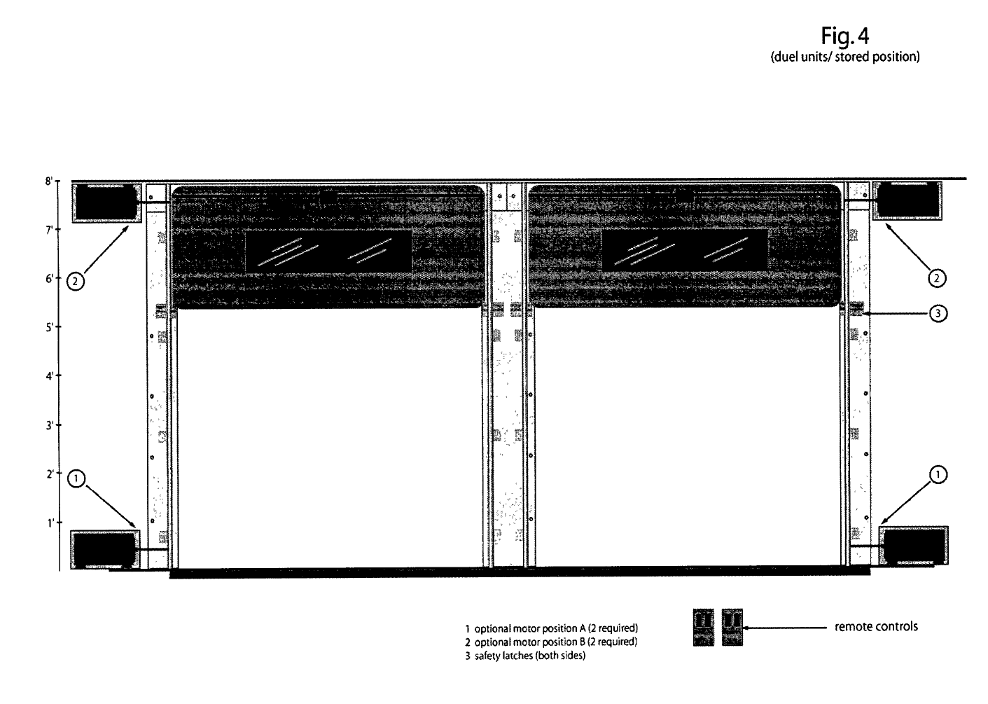

Installed at the rear of the CONTAINER is an upper and lower AXLE ASSEMBLY, FIG. 1, ITEM 18. These two AXLE ASSEMBLIES contain two WHEELS at each end, FIG. 1, ITEM 19, to guide the CONTAINER efficiently in an up and down direction. The CONTAINER WHEELS will operate in an up and down direction inside a pair of alloy steel TRACKS, FIG. 1, ITEM 10. The TRACKS will be formed alloy steel “C” section for strength and will contain the WHEELS. The TRACKS will be assembled by structural CLIPS, FIG. 1, ITEM 9, to the WOOD and METAL STRUCTURE, FIG. 1, ITEM 11, installed to the building walls and ceiling. This WOOD and METAL STRUCTURE will be of sufficient strength so as to contain all of the operating and limit loads of the items and goods to be stored. The WOOD and METAL STRUCTURE will be nailed, screwed and/or bolted to the existing wall and ceiling structure of the building. The CONTAINER will be elevated and lowered by a 110 volt or 220 volt ELECTRIC MOTOR, FIG. 1, ITEMS 5, 16 and 21. The ELECTRIC MOTOR is also attached to the WOOD and METAL STRUCTURE supporting the TRACKS and CONTAINER. The ELECTRIC MOTOR will elevate and lower the CONTAINER through the CHAIN or CABLE SPROCKET, FIG. 1, ITEM 17 attached to the ELECTRIC MOTOR prop shaft. The CHAIN or CABLE will be either an open or closed loop system for simplicity and strength. The ELECTRIC MOTOR will contain internal fault switches to prevent overloading of the system. A plastic or metal COVER, FIG. 1, ITEM 4 to prevent damage and limited access, will protect the ELECTRIC MOTOR. The ELECTRIC MOTOR and SPROCKET system will have the option of being either floor mounted or ceiling mounted, FIG. 1 through FIG. 4. This will be based on the number of units in tandem and/or space limitations.

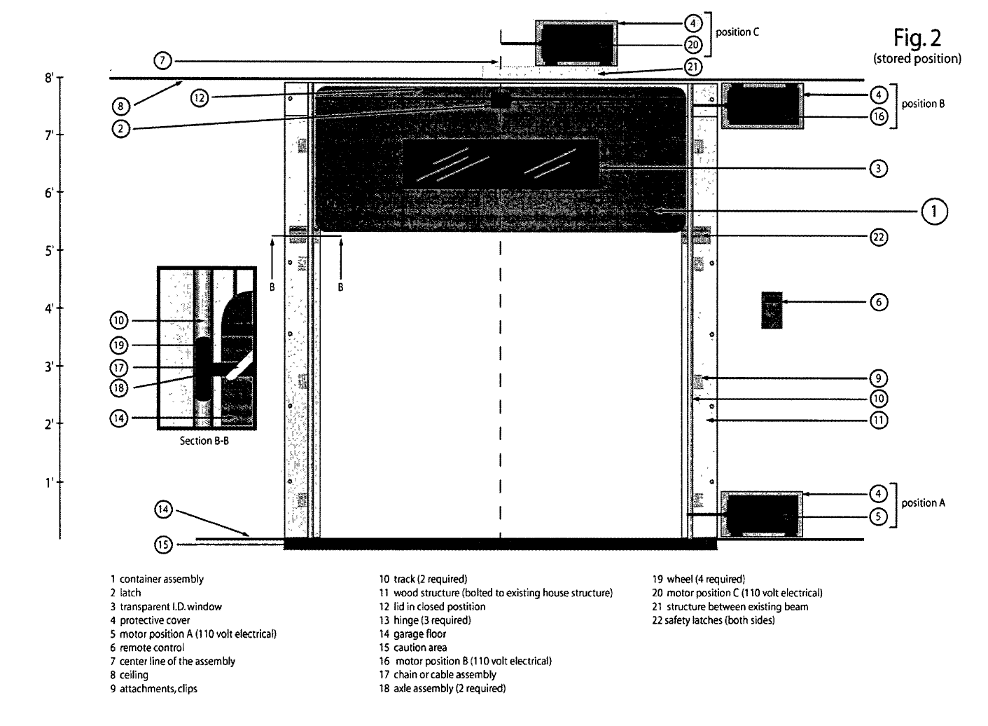

The system will have electrical switches limiting the upper and lower limits of the CONTAINER during its movement and to prevent overloading. A manual LOCKING DEVISE, FIG. 2, ITEM 23, will be installed at both tracks. This will prevent the loaded CONTAINER from descending either from accidental activation of the system or free falling. Instruction and floor placards will designate operational instructions and stayout areas during operations. These placards will be placed on the floor and/or on the wall behind the CONTAINER SYSTEM.

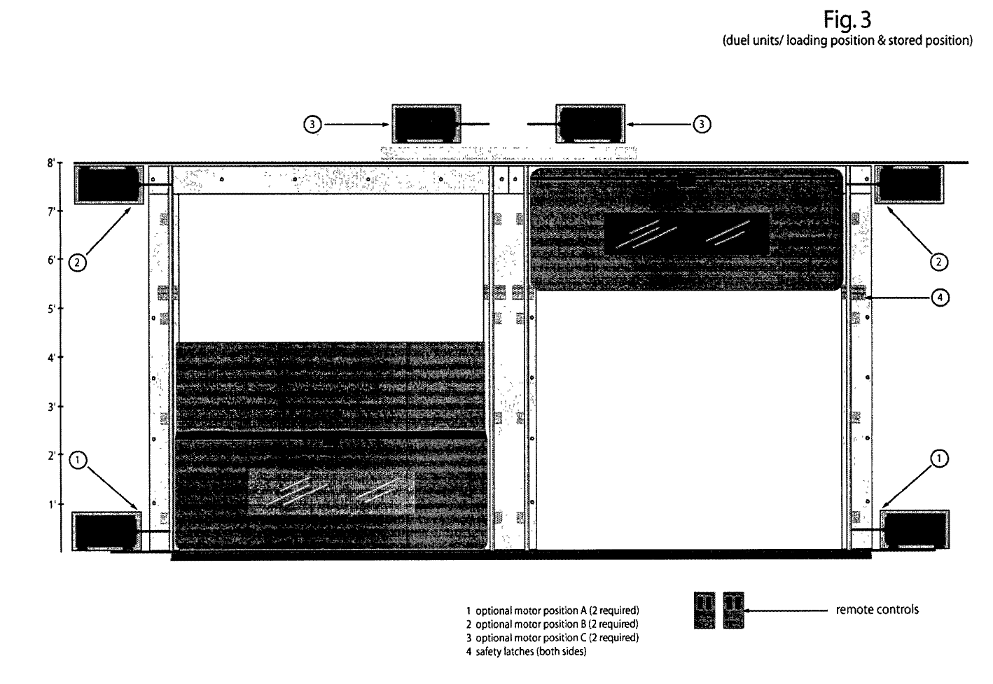

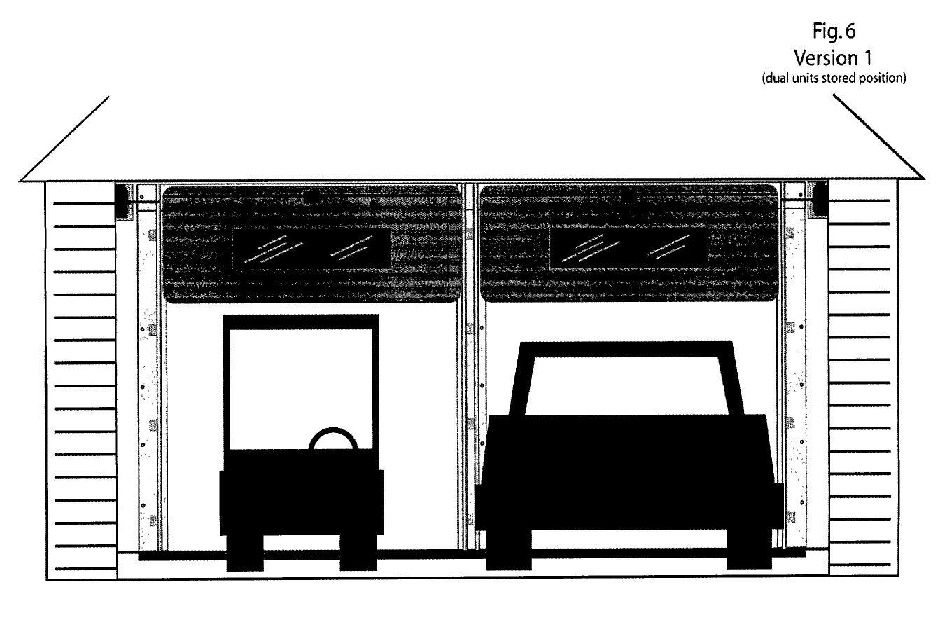

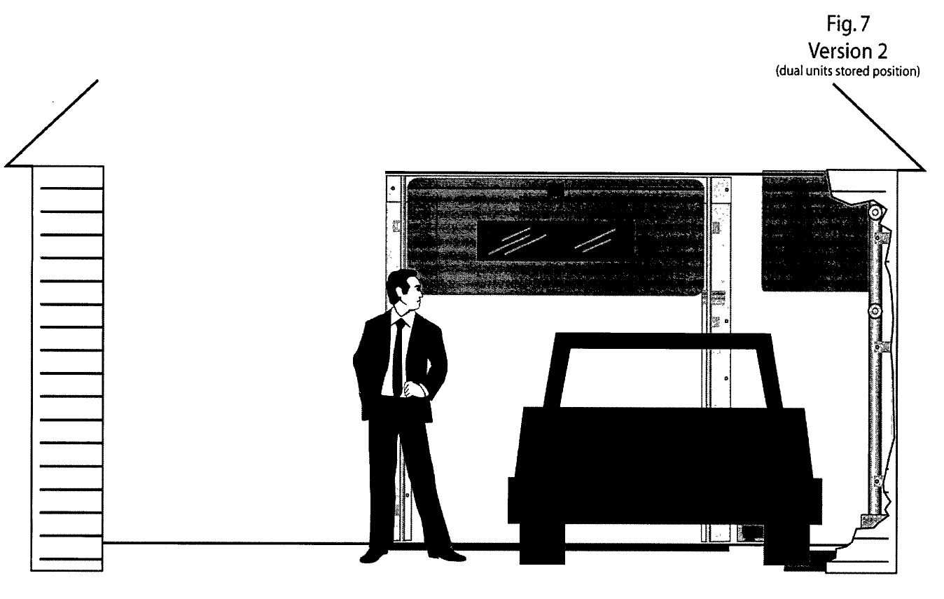

The CONTAINER SYSTEM will be operated by a HAND HELD ELECTRICAL DEVICE, FIG. 1, ITEM 6 and FIG. 6, similar to a garage door opener. It will be battery operated and contain sequence buttons for elevating and lowering the CONTAINER. The ELECTRICAL DEVICE will be capable of varying the output signal so not to interfere with surrounding electrical signals of similar type. This STOR-TEK CONTAINER SYSTEM can be installed in tandem around the surrounding structure of the building as shown in FIGS. 3, 4, 6 and 7.

I claim:

1. An overhead storage apparatus comprising:
a storage container;
a lid attached to the storage container;
an upper axle assembly mounted to the bottom of the storage container on the same side as the upper axle assembly is mounted;
a pair of upper wheels with one wheel attached to each end of the upper axle assembly;
a pair of lower wheels with one wheel attached to each end of the lower axle assembly;
a pair of tracks coupled to said upper wheels and said lower wheels wherein said upper wheels and said lower wheels are movable within said tracks;
a support structure coupled with said tracks;
means for securing said support structure to an existing building structure;
a motor attached to said support structure wherein said motor is coupled with a prop shaft at one end of the prop shaft;
a chain system with one end coupled to the prop shaft at one end of the prop shaft and with its opposite end attached to the container;
a manual locking mechanism coupled to the tracks for the purpose of preventing the container from accidentally descending down the tracks when the container is in a raised position; and
means for sending an output signal to the motor for the purpose of starting the motor to raise or lower the container.

2. The apparatus in claim 1, wherein the container is a rectangular tub-shaped assembly fabricated from plastic, composite or lightweight aluminum or steel.

3. The apparatus in claim 1, wherein the lid is a hinged lid attached to the container by means for allowing the lid to be opened while remaining attached to said container.

4. The apparatus in claim 1, wherein the lid is further attached to said container through a locking mechanism which secures the lid to the container and prevents an accidental opening of said lid.

5. The apparatus in claim 1, wherein the tracks are formed alloy steel tracks.

6. The apparatus in claim 1, wherein the tracks are formed by connecting sections of the track with structural clips.

7. The apparatus in claim 1, wherein the support structure is a metal support structure.

8. The apparatus in claim 1, wherein the support structure is a wooden support structure.

9. The apparatus in claim 1, wherein the means for securing said support structure is selected from the group consisting of nails, screws or bolts.

10. The apparatus in claim 1, wherein the motor is a 110-volt electric motor.

11. The apparatus in claim 1, wherein the motor is a 220-volt electric motor.

12. The apparatus in claim 1, wherein the chain system is a cable.
